(19) United States
(12) Patent Application Publication
(10) Pub. No.: US 2014/0185002 A1
(43) Pub. Date: Jul. 3, 2014

(54) EYEWEAR AND EYEWEAR FRAMES WITH CONTOURED TEMPLES

(71) Applicant: SMITH OPTICS, INC., Ketchum, ID (US)

(72) Inventor: Joseph R. McNeal, Hailey, ID (US)

(73) Assignee: Smith Optics, Inc., Ketchum, ID (US)

(21) Appl. No.: 13/729,611

(22) Filed: Dec. 28, 2012

(51) Int. Cl. G02C 5/14

(52) U.S. Cl. CPC G02C 5/14
USPC 351/121; 29/428

(57) ABSTRACT

Eyewear and eyewear frames are described, which may include temples having a contoured profile for a cooperating fit, for example, with circumaural headsets. Eyewear frames according to the examples herein may include a pair of temples coupled to a front portion of a frame, each of the temples having a hinge portion and an arm portion. The arm portions may bend inward from the hinge portion towards a region defined between the temples and may bend outward and curve around a head of a wearer for a conformal fit with the head of the wearer. The arm portion of the temples may further have a generally flattened profile in the transverse cross-section to provide a low profile against the head of the wearer.

### TECHNICAL FIELD

This present disclosure relates to eyewear, and particularly to eyewear and eyewear frames including temples, which may be contoured for a cooperating fit, for example, with a circumaural headset.

### BACKGROUND

Eyewear may be used by individuals utilizing circumaural headsets, such as hearing protection devices, noise cancellation or other types of audio headsets. For example, eyewear may be worn in a combat zone along while wearing or using a circumaural communication device. In other instances, an individual may wish to wear an over-the-head hearing protection device when participating in certain sports, such as hunting, or when entering a noisy environment. The temples of conventional eyewear may tend to interfere with proper fit of the headset. Certain eyewear designed particularly for use with a headset may be ineffective for use without the headset (e.g., without being secured in place by the headset). Eyewear according to the present examples may address some or all of these or other shortcomings of conventional eyewear.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several examples in accordance with the disclosure and are, therefore, not to be considered limiting of its scope, the disclosure will be described with additional specificity and detail through use of the accompanying drawings, in which:

FIG. 1 is an isometric view of eyewear according to an example of the present disclosure

FIG. 2 is a top view of the eyewear in FIG. 1.

FIG. 3 is a front view of the eyewear in FIG. 1.

FIG. 4 is a side view of the eyewear in FIG. 1.

FIG. 5 is a top view of a temple according to an example of the present disclosure.

FIG. 6 is a side view of the temple in FIG. 5.

FIG. 7 is a cross-section of the temple in FIGS. 5-6 taken along the line 7-7 in FIG. 6.

FIGS. 8A-8C are isometric, side, and top views of a temple according to another example of the present disclosure.

FIG. 9A and 9B are additional isometric views of the temple in the example in

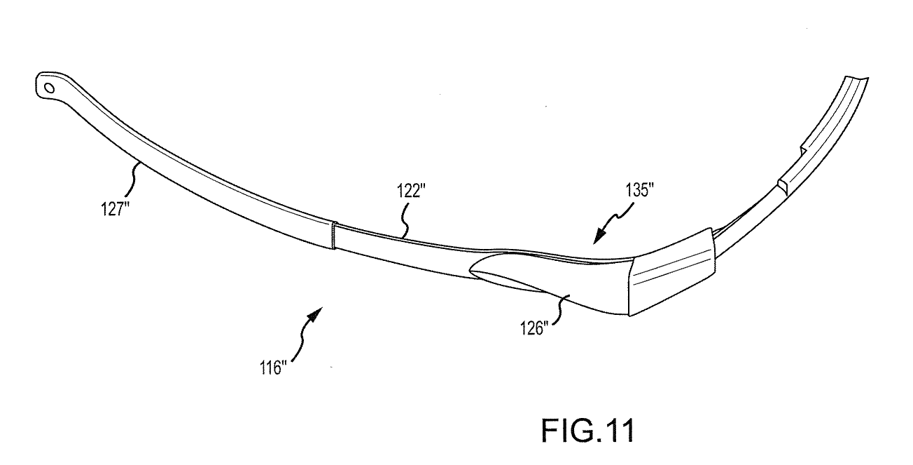

FIGS. 8A-8C.

FIG. 10 is an isometric views of a temple according to yet other example of the present disclosure.

FIG. 11 is an isometric views of a temple according to yet other example of the present disclosure.

FIG. 12 is a flow diagram of a method according to the present disclosure.

### DESCRIPTION

In the following detailed description, reference is made to the accompanying drawings, which form a part hereof. In the drawings, similar symbols typically identify similar components, unless context dictates otherwise. The illustrative examples described in the detailed description, drawings, and claims are not meant to be limiting. Other examples may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are implicitly contemplated herein.

As briefly described above, eyewear may frequently be worn in conjunction with a circumaural headset, whether used for protection (e.g., hearing protection), for audio communication (e.g., circumaural audio communication devices), or for other reasons. Typical eyewear may include a lens and a frame, the frame generally consisting of a front portion or rim which engages the lens, and side portions, typically known as temples. A shortcoming of conventional eyewear is their tendency to cause an improper and/or uncomfortable fit when worn with a circumaural headset. Typically, the temples of conventional eyeglasses extend generally straight back and/or outward from the hinge causing the temples to be spaced apart from the head of the wearer. As such, conventional eyeglasses fail to provide a sufficiently conformal fit against the wearer's head as may be necessary to obtain a good seal of the circumaural headset against the head of the wearer. Rather, the temples may tend to break the seal of the earmuffs reducing their effectiveness and/or resulting in an uncomfortable and improper fit. As a solution to the fit problem, conventional eyewear intended for use with a headset may have temples made from a substantially flexible material which can be forced to conform to the head of the wearer when a headset is placed over the wearer's head. In effect, the clamping force of the headset is generally relied upon to retain the eyewear in place. The temples of such eyewear, however, is typically too flexible to maintain the eyewear in place when the headset is removed, and as such, the eyewear is generally unsuitable to wear without simultaneously wearing the headset. Accordingly, currently known solutions may be deficient and alternate solutions to this problem may be needed, examples of which are described herein.

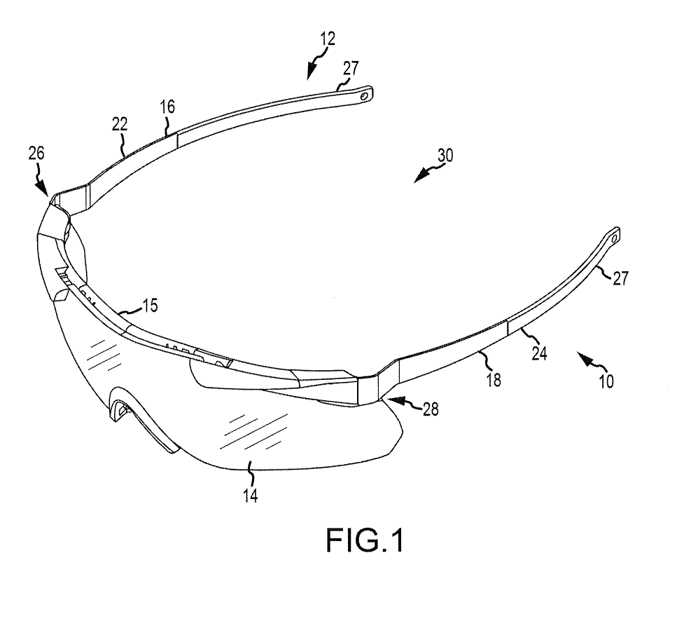

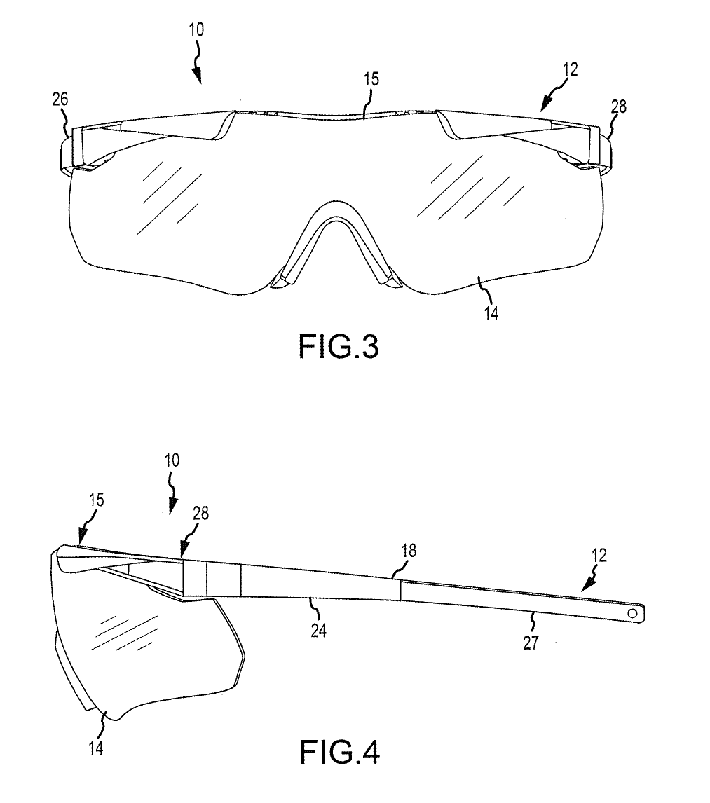

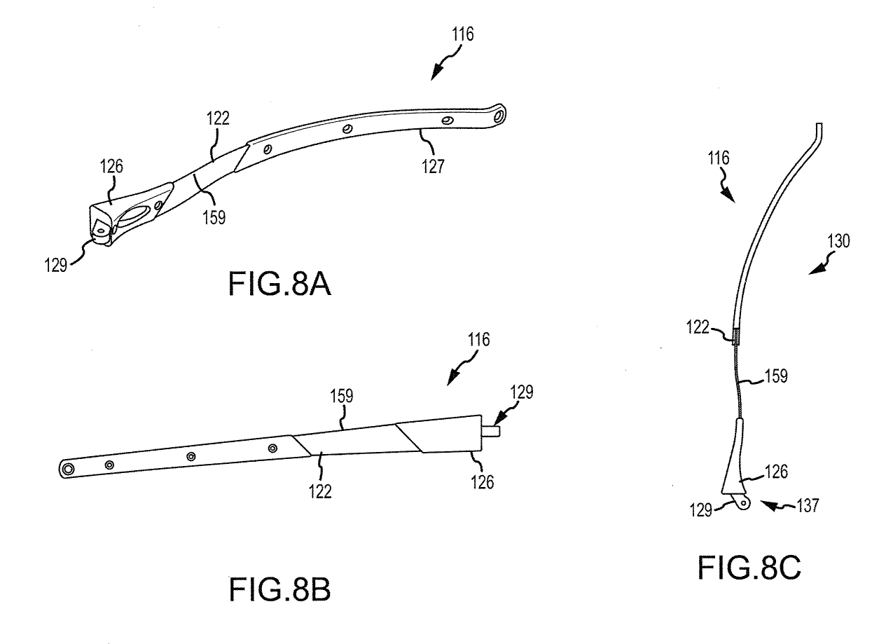

FIGS. 1-4 are isometric, top, front, and side views of an example eyewear according to the present disclosure. The eyewear 10 includes a frame 12 and a lens 14. The lens 14 may be unitary and formed from glass or other transparent material, as depicted in FIG. 1. In other examples, the eyewear 10 may include two individual lenses (not shown) configured to extend across each eye of the wearer. The frame 10 may include a front portion 15 and a pair of temples 16, 18. A first temple 16 may be hingedly coupled to one side of the front portion 15 using a first hinge portion 26. The second temple 18 may be hingedly coupled to the opposite side of the front portion 15 using a second hinge portion 28. The first and second hinge portions 26, 28 may each include a hinge barrel portion 29 (see FIG. 5), which may be configured for passing a pin therethrough for pivotally coupling the hinge barrels of hinge portions 26, 28 to receiving hinge barrel portions at opposite ends of the front portion 15.

Each of the temples 16, 18 may include first and second arm portions 22, 24 extending from the first and second hinge portions 26, 28, respectively. As will be described in further detail below, the arm portions 22, 24 of each of the first and second temples 16, 18 may be shaped to substantially conform to a head of a wearer along the length of each arm portion.

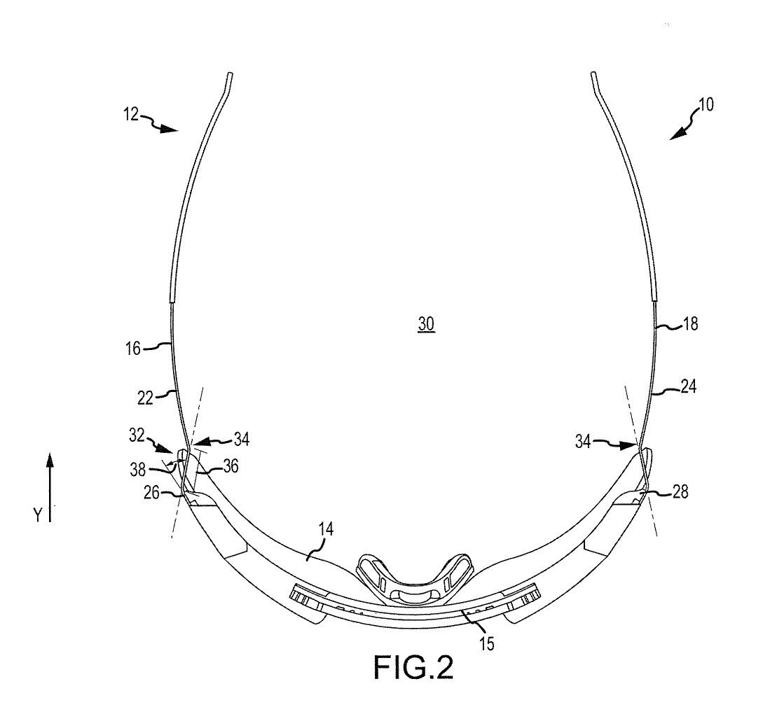

Each arm portion 22, 24 may have a proximal segment 42 (see FIG. 5) spanning from the hinge to the apex 34 as will be further described, and a distal segment 44 (see FIG. 5) extending from the apex to the distal end of the temples. The apex 34 may define a transition between the proximal segment 42 and the distal segment 44 of the arm portions 22, 24. Each arm portion 22, 24 may bend inward from respective ends of the hinge portions 26, 28 towards a region 30 defined between the temples (see FIG. 2) along proximal segments 42 of each arm portion. The arm portions 22, 24 may bend outward from the apex 34 away from the region 30 defining a concave portion 32. In the present context, the term concave may be interpreted to mean that the portion 32 is shaped such that it generally curves inward or towards the region 30, as can be seen for example in the top view shown in FIG. 2. The arm portions 22, 24 may curve around following the contour of the wearer's head along the length of respective distal segments 44 of the arm portions 22, 24. In this regard, a generally convex profile may be defined by the distal segments 44 of each temple, also as can be seen in the top view shown in FIG. 2. In this manner, in some examples, a complex curve or s-shaped curve may be defined along the length of each arm portion, with the proximal segment jogging inward towards the head of the wearer (e.g., towards the general temple region of the wearer's head) and following a closely conforming profile to the head of the wearer thereafter. As will be further described, eyewear according to the present examples may result in a low profile fit which may allow a headset to be simultaneously worn over the eyewear without the discomfort and diminished functionality associated with conventional glasses.

As shown in FIG. 2, the apex 34 points inward towards the region 30 defined between the temples. The proximal segment 42 may have a length 36 and may bend inward at a jog angle 38 which may be selected based on any number of design parameters. For example, some parameters that may be considered in selecting the length 36 and/or jog angle 38 may include the overall size of the frame, the shape of the wearer's head, the amount of curvature of the lens, the amount of offset of the lens from in front of the face of the wearer, as well as other considerations. Other parameters may be considered to obtain a low profile fit as described herein.

In some examples, the arm portions 22, 24 may be shaped such that a distance between the apexes 34 of the respective arm portions is less than a distance between respective ends of the hinge portions 26, 28. In some examples, the distance between the apexes 34 of the respective arm portions is less than the distance between any two opposing locations along the respective proximal segments 42. In some examples, the distance between the apexes 34 of the respective arm portions may be less than the distance between any two opposing locations along the respective distal segments 44. In some examples, the distal segments 44 of each arm portion may have a substantially convex curvature which may correspond to the curvature of the head of the wearer. In this manner, temples according to the present disclosure may be provide a low profile fit which may allow a headset to be comfortably worn over the eyewear while maintaining a proper seal between the cups of the circumaural headset and the wearer's head.

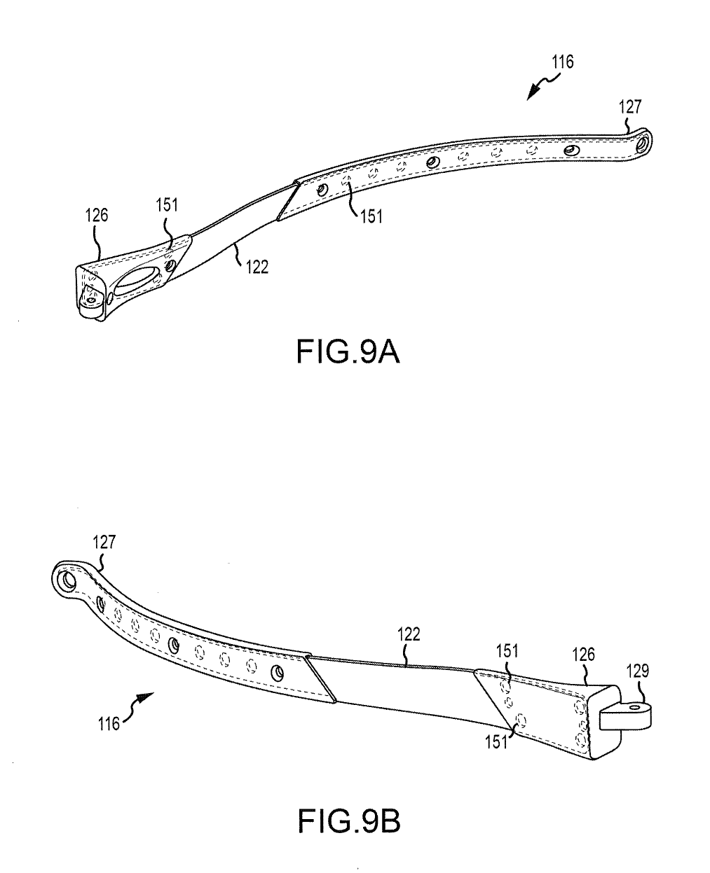

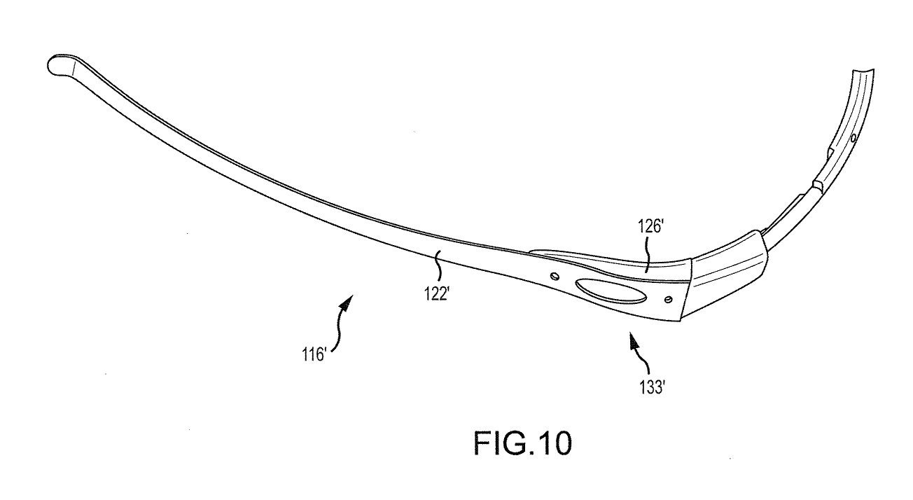

FIG. 5 is a top view, FIG. 6 is a side view of temple 18 of the example illustrated in FIGS. 1-4. FIG. 7 is a transverse cross-section of the temple 18 taken along the line 7-7 in FIG. 6. As will be appreciated, some of the features in the figures may or may not be to scale and may be provided for illustration purposes only. Referring now to FIGS. 5-7, additional features and advantages of the present disclosure may be appreciated. While only one temple of the pair of temples is depicted and described in further detail, it will be understood that temples 16 and 18 may include many or all of the same features.

In the present example, the temple 18 may have a rectangular cross-section defined by a height 46 and a thickness 48. In other examples, other transverse cross-sectional shapes different than the rectangular cross-section depicted in FIG. 7 may be used instead. For example, elliptical, half elliptical, slender rhomboid or half rhomboid shapes, a curved rectangular shape or virtually any other irregular flattened shape adapted to provide a close fitting or low profile temple may be used without departing from the scope of this disclosure.

As depicted in the figures, temples according to the present examples may have a generally flattened cross-sectional profile. The term “flattened” implies a relatively large height to thickness ratio. For example the height to thickness ratio at least at one position along the length of the temple may be at least 10:1, or in some examples, at least 15:1. The height to thickness ratio of temples according to other examples may be 20:1 or greater. The height of the temple may be taken at any position along its length, and the height is not limited to being the same along the length of the temple and may vary along the length.

In a non-limiting example, a thickness 48 of the temple 18 may be up to about 1 mm thick. The thickness 48 of the temples may be constant or it may vary along the length of the temple (e.g., along the direction Y. In some examples, the thickness 48 may be about 0.7 mm or less, or about 0.5 mm or less. In other examples, the temples may be about 0.63 mm thick. As described, a height 46 of the temples may be at least 10 times the thickness 48, or in other examples the height 46 may be at least 15 times the thickness 48.

In some examples, the height 46 of the temple may taper from a first height 46′ to a second height 46″. The first height 46′ may be about 10 mm or greater and the second height 46″ may be about 5 mm or greater. In other examples, the height 46 of the temple may remain substantially constant along the longitudinal direction. In some examples, the height 46 of each of the temple may be about 7 mm or more.

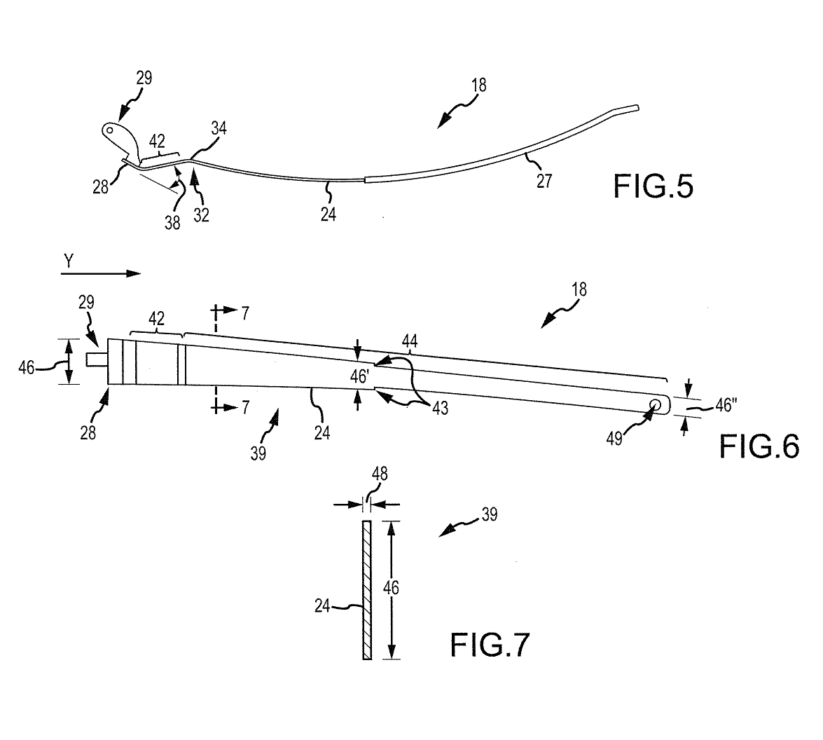

As depicted in the side views in FIGS. 4 and 6, the arm portion of the temple may be generally straight along the Y direction, or the arm portion may curve down, for example for securing the distal end of the temple around the ear of the wearer.

As depicted in the figures, each temple (e.g., temple 16, 18) may be implemented as a flattened elongated member 39. The elongated member 39 (e.g., temple 16, 18) may be made from a metal, such as stainless steel. Other materials may also be used, for example titanium, aluminum alloys, or others alloys. Plastics or composites (e.g., fiber reinforced or laminated materials) with suitable moduli of elasticity may be used instead of or in combination with metallic materials for the temples according to the present disclosure. In other examples, a combination of metal and plastic may be used, as shown in FIGS. 8-12 and as will be further described with reference to those figures. As will be understood, in some examples, the materials and/or particular geometry of temples according to embodiments of the invention may be tailored to achieve temples which are sufficiently flexible or resilient to allow a wearer to adjust the fit of the frame. The temples may be sufficiently flexible so that a wearer may be able to bend the temples inward toward or outward away from region 30 to a deformed shape, yet the temples may retain the deformed shape.

In examples in which the temples are implemented from metal, the temples may be formed by stamping or cutting the elongated members from sheet metal and bending the elongated metal members as may be desired to obtain the curvature of each temple. Each elongated metal member may be bent in a first direction to define the inward jog (e.g., the proximal segment 42) of the arm portion 24, and then bent in a second direction opposite the first direction to form the apex 34. The distal segment 44 of the temple may be shaped to a curvature adapted to fit conformally and comfortably against the head of a wearer. As will be appreciated, the temples according to the present disclosure may simultaneously offer a low profile (e.g., fit conformally and closely to the head of the wearer) while being sufficiently structurally stable to retain their shape when worn without a circumaural headset.

A layer of non-metallic material (e.g., pad 27) may be included over the distal end of the elongated member 39 for additional comfort and/or advantages for the wearer. For example, the pad 27 may be an overmold of a tacky rubber material, such as thermoplastic elastomer (TPE). The pads may cushion the ends of the temples against the wearer's head and provide friction for retaining the eyewear in place (e.g., in contact with the wearer's head). The pad 27 may be positioned over the distal end of the arm portion 24 such that it protrudes from the arm portion 24. In other examples, additional shaping, such as detents 43, may be used to recess the pad relative to the arm portion 24 and achieve a more streamlined profile. The pad 27 may be slid into place and may be removable, or the pad 27 may be molded over the arm portion 24 using conventional injection molding techniques. Locator features, for examples through holes, indents, or protrusions, on one or more surfaces of the arm portion 24, may be used to locate and retain the arm portion in place during manufacture. For example, a through-hole 49 may be used to locate and hold the arm portion 24 stationary during injection molding of the pad 27.

As previously discussed, while only temple 18 has been depicted and previously described in detail with reference to FIGS. 4-7, it will be understood that temple 16 may include some or all of the same features previously described and illustrated with respect to temple 18.

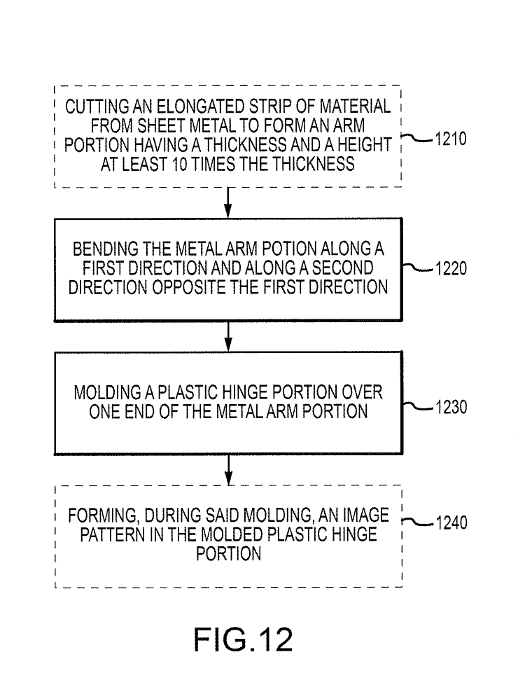

In some examples, and as shown in FIGS. 8-11, temples according to the present disclosure may include a metal arm portion and a non-metal hinge portion. FIGS. 8-9 are various views of a temple according to another example of the present disclosure, and FIGS. 10 and 11 illustrate yet other examples of temples according to the present disclosure.

The temple 116 in the FIGS. 8-9 includes a metal arm portion 122 and a non-metal hinge portion 126, which may in some examples be plastic. The metal arm portion 122 of the temple 116 may be similar to the distal segment 44 of the metal temples 16, 18 described above. The metal arm portion 122 of the temple 116 may be implemented as a flattened elongated metallic member 159 similar to the elongated member 59 described above with reference to the example in FIGS. 1-7. As shown in FIGS. 8A-8C, the metal arm portion 122 of the temple 116 may be configured to substantially conform to the head of a wearer, in a similar fashion to the distal segment 44 of the metal temples 16, 18 described above. The metal arm portion 122 may have a complex s-shape curvature bending inward from the hinge end 137 and bending out and around to define a curvature corresponding to a head of a wearer. A portion of the elongated metallic member 159 may be coupled to the hinge portion 126 as will be further described.

The hinge portion 126 of the temple 116 may be made of virtually any rigid plastic material, for example nylon or a PC/ABS blend plastic. Other plastic materials, such as impact resistant nylon, composites, such as fiber reinforced or core stiffened materials, may be used instead of or in combinations as may be desired. The hinge portion 126 may include a hinge barrel 129 configured for pivotally coupling to receiving hinge barrel portions at a front portion of an eyewear frame (not shown). For example, the hinge portion 126 may be coupled to the front portion 15 (of frame 12 previously described).

In a manner similar to the proximal segments of the metal temples 16, 18 described above, the hinge portion 126 of the present example may be configured to jog inward from the hinge end 137 towards a region defined 130 defined between two opposing temples. By shaping the hinge portion 126 in this manner, the metal arm portions which are coupled to the hinge portion may be brought in near contact with the head of the wearer to achieve the low profile, conformally fitting eyewear described herein. The hinge portion 126 may substantially follow the contour of the metal arm portion enclosed therein. The hinge portion 126 may be wider near the hinge end 137, for example for providing structural stability of the eyewear frame at the hinge.

The hinge portion 126 may be coupled to the metal portion 116 using any of a variety of techniques. An end of the metal arm portion may be enclosed by the hinge portion (e.g., molded over the proximal end of the metal arm portion) as shown in the examples in FIGS. 8-9, or the metal arm portion may be attached to an exterior surface of the hinge portion, as shown in the examples in FIGS. 10 and 11. The metal arm portion may be attached to either side of the hinge portion. For example, and as shown in FIG. 10, the metal arm portion 122′ may extend along the outer surface 133′ of the hinge portion 126′ and be attached to the surface 133′, for example by an adhesive or a mechanical fastener. In other examples, and as shown in FIG. 11, the metal arm portion 122″ may extend along the inner surface 135″ of the hinge portion 126″ and be attached to the surface 135″ with the use of an adhesive, a mechanical fastener, or any other conventional technique. In yet other examples, the metal arm portion may be coupled to an end of the hinge portion opposite the hinge end 137.

Referring now to FIGS. 9A and 9B, additional features relating to the manufacturing of temples according to this disclosure will be described and appreciated. FIGS. 9A and 9B are isometric views of the temple 116 in the example shown in FIGS. 8A-8C. Certain features, for example the proximal end of the metal arm portion enclosed by the hinge portion, are shown in phantom to illustrate additional advantageous features of the present examples. As shown, the proximal or enclosed end of the arm portion may be provided with through features to facilitate better attachment between the metal and plastic portions. For example, holes, of virtually any shape or size, may be formed through the proximal end of the metal arm portion 122 to allow plastic material to flow through the holes during the molding process. In this manner enhancing interlocking and/or adhesion between the plastic and metal portions may be achieved. In other examples, surface features (e.g. detents or protrusion) may be provided on the enclosed metal portion, or its surface may otherwise be textured (e.g., roughening the surfaces to be enclosed) to facilitate a better bond between the plastic overmold and the metal portion.

One or more pads 127 may be provided at a distal end of the arm portion. In a similar manner to the pads 27, the one or more pads 127 may receive the thin metal member or the pads 127 may be molded over in a non-removable manner using techniques as described with reference to the non-metal hinge portion, or other conventional techniques known in the art.

FIG. 11 shows a flow diagram of a method according to the present disclosure.

Techniques for forming temples, for example temples including an overmolded plastic hinge portion, will be described in further detail with reference to FIGS. 9 and 12. An example method for forming eyewear frame temples may include shaping an elongated metallic member and molding a plastic member over one end of the elongated metallic member. The shaping of the elongated metallic member (e.g. metal arm portion) may include bending the metal arm portion along a first direction and along a second direction opposite the first direction, as shown in box 1220, to impart an s-shape curvature to the metallic member. In some examples, the first direction may be towards

The elongated metallic member may have a height and a thickness, the height being at least ten times greater than the thickness. In some examples an option step, as shown in dashed box 1210, may be cutting an elongated strip of material from sheet metal having a gage corresponding to the desired thickness. The cutting may be achieving using conventional stamping or die cutting processor or other machining techniques. The elongated strip of material may be coated and/or treated (e.g. polished or brushed), as may be desired. The elongated strip of material may then be bent to define the curvature of the metal arm portion.

In the case of a fully metal temple, a hinge member (e.g. hinge barrel portion) may be attached to one end of the metal arm portion, for example by welding or other conventional techniques. In the case of a partially metal partially non-metal temple, a hinge portion, which may be made of plastic may be coupled to one end of the metal arm portion. The hinge portion may include a hinge barrel portion for pivotally coupling the temple to a frame. As shown in box 1230, the hinge portion may be molded over the end of the metal arm portion using injection molding techniques. During the injection molding process, a clamping force may be applied to the part being molded over (e.g. the metal arm portion) to hold he part stationary within the mold while plastic is injected into the mold. A unique aspect of the molding process according to this disclosure is the use of the mold tool to form an image pattern (see e.g., logo formed in the plastic hinge member in FIG. 8B), as shown in box 1240. In some examples, one or more of the holding member used for clamping down the metal arm portion in the mold is shaped with a negative image of the desired pattern, thereby allowing a positive image of the desired pattern (e.g. a logo) to be formed through the plastic on one side of the metallic member during the molding process.

Examples of eyewear, eyewear frames, and methods for forming same are described herein. An eyewear frame according to one example may include a pair of metal temples hingedly coupled to a front portion of the frame. Each of the metal temples may include a hinge portion and an arm portion which bends inward from the hinge portion towards a region defined between the temples. In some examples, the metal temples may be formed from stainless steel or any other suitable metallic material.

Each of the arm portions may be configured to have a generally flattened profile.

For example, a height of the arm portion at a particular location of the arm portion (e.g., first height) may be at least ten times a thickness of the arm portion at that location. The height of the arm portion may taper from the first height to a second height. In some examples, the first height of the arm portion may be about 10 mm or greater and the second height may be about 5 mm or greater. The thickness of the arm portion may be substantially constant along a longitudinal direction of the arm portion. The thickness of the arm portion may be about 0.7 mm or less, or it may range from about 0.4 mm to about 0.7 mm. In some examples, the thickness of the arm portion may be about 0.5 mm or less.

According to another example, an eyewear frame may include a front portion, a first temple and a second temple. The first and second temples may be hingedly coupled to the front portion of the frame, and each of the first and second temples may include a plastic hinge portion and a metal arm portion. In some examples, the plastic hinge portion may be molded over a first end of the metal arm portion, or in other examples, the metal arm may be attached to a surface of the plastic hinge portion. The metal arm portion may be made of stainless steel, and the plastic hinge portion may be made of nylon, PC/ABS blend plastic or from other plastics or composite materials. The plastic hinge portion may include a hinge barrel portion configured for hingedly coupling the first and second temples to the frame. In some examples, each of the first and second temples may further comprise a pad attached to an end of the metal arm portion opposite the plastic hinge portion.

An eyewear according to the examples herein may include a lens and a frame. The frame may include a first temple and a second temple, each of said first and second temples including a hinge portion and an arm portion. The arm portion of each of the first and second temples may have a height and a thickness, the ratio of the height to the thickness being 10:1 or greater. In some examples, the height to thickness ratio may be 15:1 or greater. The arm portion of each of the first and second temples may be configured to conform to a head of a user. In this regard, the eyewear may provide a low profile configuration suitable for use with circumaural headsets. In some examples, the hinge portion of each of the first and the second temples may be made of plastic, or in other examples, the first and second temples may be entirely made of metal. Stainless steel may be used allowing the eyewear frame to retain its shape and remain in conforming fit with the wearer's head when no headphones are worn.

As will be appreciated, some of the advantages of eyewear and eyewear frames according to the examples herein may include their ability to be worn comfortably and effectively with circumaural headsets. Many other advantages of the examples described will be appreciate in light of the present disclosure and will be apparent to those skilled in the art. The various aspects and examples disclosed herein are for purposes of illustration and are not intended to be limiting, with the true scope and spirit being indicated by the following claims.

What is claimed:

1. An eyewear frame comprising:
a front portion; and
a pair of metal temples hingedly coupled to the front portion, wherein each of the metal temples include a hinge portion and an arm portion which bends inward from the hinge portion towards a region defined between the temples.

2. The eyewear of claim 1, wherein a first height of the arm portion is at least ten times a thickness of the arm portion.

3. The eyewear of claim 2, wherein the arm portion tapers from the first height to a second height.

4. The eyewear of claim 3, wherein the first height is about 10 mm or greater and the second height is about 5 mm or greater.

5. The eyewear of claim 2, wherein the thickness of the arm portion is constant along a longitudinal direction of the arm portion.

6. The eyewear of claim 1, wherein a thickness of the arm portion is about 0.7 mm or less.

7. The eyewear of claim 1, wherein the arm portion comprises:
a proximal segment spanning from the hinge portion to an apex, wherein the proximal segment including the inward bend from the hinge portion; and
a distal segment extending from the apex to a distal end of the arm portion, wherein the distal segment bends outward from the apex away from the region defined between the temples.

8. The eyewear of claim 1, wherein the metal temples comprise stainless steel.

9. An eyewear frame comprising:
a first temple and a second temple hingedly coupled to a front portion of the frame, each of the first and second temples including a plastic hinge portion and a metal arm portion.

10. The eyewear frame of claim 9, wherein the plastic hinge portion is molded over a first end of the metal arm portion.

11. The eyewear frame of claim 9, wherein the metal arm is attached to a surface of the plastic hinge portion.

12. The eyewear frame of claim 9, wherein each of the first and second temples further comprise a pad attached to an end of the metal arm portion opposite the plastic hinge portion.

13. The eyewear of claim 9, wherein the metal arm portion is made of stainless steel and the plastic hinge portion is made of nylon.

14. The eyewear of claim 9, wherein the plastic hinge portion includes a hinge barrel portion configured to hingedly couple the first and second temples to the frame.

15. The eyewear of claim 9, wherein the first and second temples include respective hinge ends hingedly coupled to the front portion, and the first and second temples jog inward from the respective hinge ends towards a region defined between the first and second temples.

16. Eyewear comprising:
a lens; and
a frame including first and second temples, and further including a front portion coupled to the lens, each of said first and second temples including a hinge portion and an arm portion, the hinge portion of the first and second temples coupled to the front portion, and the arm portion has a height and a thickness with a ratio of the height to the thickness being 10:1 or greater.

17. The eyewear of claim 16, wherein the arm portion of each of the first and second temples is configured to conform to a head of a user.

18. The eyewear of claim 16, wherein the hinge portion of each of the first and the second temples is made of plastic.

19. The eyewear of claim 16, wherein the first and second temples are made of metal.

20. A method of forming an eyewear frame temple, the method comprising:
shaping an elongated metallic member to impart a first curvature to the metallic member in a first direction and a second curvature in a second direction opposite the first direction; and
molding a plastic member over one end of the elongated metallic member, the plastic member including an annular portion for pivotally attaching the temple to an eyewear frame.

21. The method of claim 20, wherein the elongate metallic member has a height and a thickness, the thickness being at least eight times less than the height, and wherein said first direction is generally perpendicular to the height.

22. The method of claim 20 further comprising, during said molding, applying a clamping force to first and second opposing holding members each disposed on opposite sides of the metallic member.

23. The method of claim 22, wherein at least one of said first or second holding member is configured to form a logo over mold on one of the sides of the metallic member.
